(19) United States
(12) Patent Application Publication
(10) Pub. No.: US 2025/0051627 A1
(43) Pub. Date: Feb. 13, 2025

(54) SHALE INHIBITORS AND SYSTEMS AND METHODS RELATED THERETO

(71) Applicant: SAUDI ARABIAN OIL COMPANY, Dhahran (SA)

(72) Inventors: Mohammed Khaled AL-ARFAJ, Dhahran (SA); Hassan ALQAHTANI, Dhahran (SA); Turki Thuwaini ALSUBAIE, Dhahran (SA); Hussain SHATEEB, Dhahran (SA)

(73) Assignee: SAUDI ARABIAN OIL COMPANY, Dhahran (SA)

(21) Appl. No.: 18/366,541

(22) Filed: Aug. 7, 2023

(51) Int. Cl. C09K 8/06; E21B 21/00

(52) U.S. Cl. CPC C09K 8/06; E21B 21/00; C09K 2208/12

(57) ABSTRACT

Drilling fluids, methods, and systems for drilling a subterranean formation. Drilling fluids include an aqueous base fluid and a shale inhibitor comprising cetyltrimethylammonium bromide. Methods include providing the drilling fluid and drilling at least a portion of a wellbore into a subterranean formation in the presence of the drilling fluid. Systems include a drill string extendable into the wellbore from a drilling platform and conveying the drilling fluid to a drill bit arranged at a distal end of the drill string. The subterranean formation may be a shale subterranean formation.

### FIELD OF THE DISCLOSURE

The present disclosure relates generally to subterranean drilling operations and, more particularly, to subterranean drilling operations using drilling fluid comprising shale inhibitor composed of cetyltrimethylammonium bromide.

### BACKGROUND OF THE DISCLOSURE

During drilling operations, a drilling fluid, which may also be referred to as drilling mud, is circulated through the wellbore to cool the drill bit, maintain the rheology of the drilling fluid, manage hydrostatic pressure in the wellbore, lubricate the drilling bit, prevent fluid loss into the formation, transport rock cuttings to the surface, and prevent the swelling of shale formation, among other purposes. Drilling fluids are formulated to have certain fluid characteristics, such as density and rheology, for example, which allow the drilling fluid to perform these functions. Drilling fluids can be categorized into two major categories-oil-based drilling fluids and aqueous-based drilling fluids. Oil-based drilling fluids have superior inhibition properties, excellent lubricity, and high-temperature stability. However, the high cost and the increasing concerns of environmental toxicity have led to limitation of oil-based drilling fluids in drilling applications. On the other hand, aqueous-based drilling fluids pose relatively lower environmental threat in comparison to oil-based drilling fluids while maintaining ideal rheological properties and performance with the inclusion of various additives. The use of aqueous-based drilling fluids, however, in the presence of reactive shales, which comprise clays, often result in detrimental impacts to wellbore integrity due to swelling of the clay, for example. The presence of various clay minerals in shale leads to shale swelling.

As previously mentioned, a major issue of aqueous-based drilling fluids in the presence of clay-rich shale formations is shale swelling, which can lead to instability during wellbore drilling at least by causing issues such as sloughing, bit balling, caving, high drag and torque, stuck pipe, disintegration of shale cuttings due to water adsorption to reactive shales. Wellbore instability can lead to financial loss, as well as non-productive time, through the loss of drilling assembly equipment, loss of circulation, and including partial or complete loss of the well.

To combat the swelling effect of water-based (drilling) mud (“WBMs”) in shale formations, shale inhibitor additives may be included within a WBM. Shale inhibitors function as an anti-swelling agent by decreasing the dispersion of clay-water interactions. Examples of conventional shale inhibitors include inorganic salts, such as sodium chloride (NaCl), potassium chloride (KCl), calcium chloride (CaCl₂)), ammonium chloride (NH₄Cl), and divalent brine electrolyte solutions. Other conventional shale inhibitors include organic polymers, polyglycols, polyglycerols, silicates, polyamines, and nanomaterials. The success of any particular shale inhibitor may depend on a number of factors including at least the composition of the shale formation.

With respect to the aforementioned considerations, the present disclosure provides compositions, systems, and methods for stabilizing shale formations from swelling effects of WBM using a shale inhibitor comprising cetyltrimethylammonium bromide.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method is provided including providing a drilling fluid comprising: an aqueous base fluid, and a shale inhibitor comprising cetyltrimethylammonium bromide (CTAB); and drilling at least a portion of a wellbore into a subterranean formation in the presence of the drilling fluid.

According to an embodiment consistent with the present disclosure, a drilling fluid is provided including an aqueous base fluid, and a shale inhibitor comprising cetyltrimethylammonium bromide (CTAB).

According to an embodiment consistent with the present disclosure, a system is provided including a drill string extendable into a wellbore from a drilling platform and conveying a drilling fluid to a drill bit arranged at a distal end of the drill string, the drilling fluid comprising: an aqueous base fluid, and a shale inhibitor comprising cetyltrimethylammonium bromide (CTAB).

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is cross-sectional side view of an example well system that may incorporate one or more principles of the present disclosure.

FIG. 2 is an x-ray diffraction chart of a lower Silurian shale formation sample.

FIG. 3 is an x-ray diffraction chart of cetyltrimethylammonium bromide.

### DETAILED DESCRIPTION

The present disclosure relates generally to subterranean drilling operations and, more particularly, to subterranean drilling operations using drilling fluid comprising shale inhibitor composed of cetyltrimethylammonium bromide (CTAB).

Various embodiments of the present disclosure will be described in detail with reference to the accompanying Figures. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

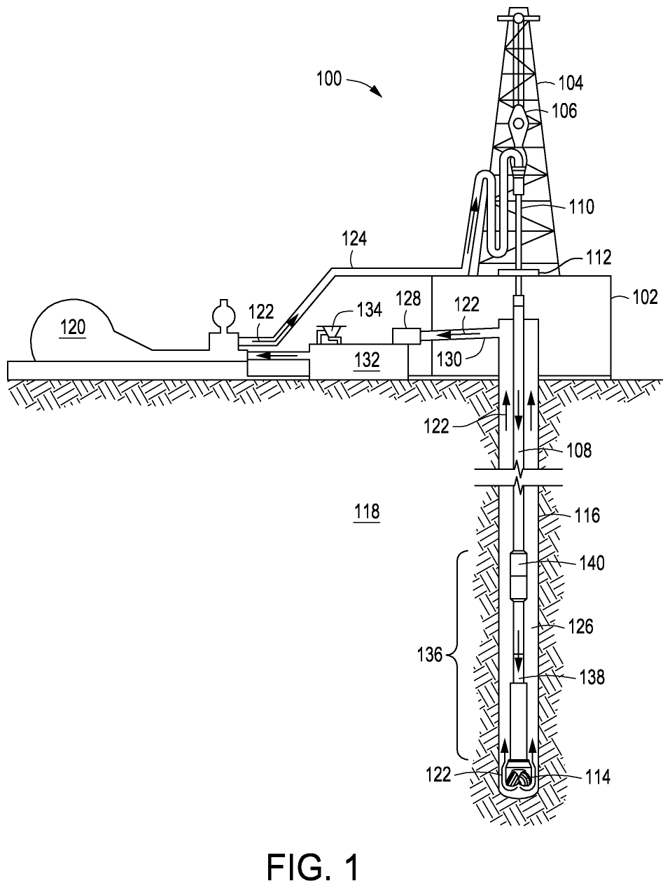

To drill a subterranean wellbore, and as described in more detail with reference to FIG. 1 below, a drill string including a drill bit is inserted into a predrilled hole and rotated to cause the drill bit to cut into the formation rock at the bottom of the hole, producing rock cuttings. To remove the rock cuttings from the bottom of the wellbore, a drilling fluid is pumped down through the drill string to the drill bit. The drilling fluid cools the drill bit and lifts the rock cuttings away from the drill bit. The drilling fluid carries the rock cuttings upwards as the drilling fluid is recirculated back to the surface. At the surface, the rock cuttings are removed from the drilling fluid, and the drilling fluid is then recirculated back down the drill string to the bottom of the wellbore. The term “rock cuttings,” and grammatical variants thereof, is intended to include any fragments, pieces, or particulates separated from the formation by the drill bit or otherwise present in the wellbore.

Under certain extreme downhole conditions, such as excessive temperature or difficult formations, some of the properties of conventional drilling fluids may be altered. As briefly described above, clay-rich shale formations are often affected by aqueous-based drilling fluids because they comprise water-swellable clay minerals, and therefore, have a high inclination for swelling and dispersing in water. Consequently, this may result in wellbore collapse, stuck pipes, lost circulation, and other wellbore-related issues. The reactive nature of shales upon encountering aqueous fluids (especially from aqueous-based drilling fluid) can lead to wellbore instability and lead to non-productive time. Traditional shale inhibitors include various electrolytes such as those described above for water sensitive shale formations. These electrolytes are used in various concentrations based on the shale formation and any additives included in an aqueous-based drilling fluid. The high concentrations of these electrolytes prevent shale hydration and swelling of water sensitive shale formations. However, a high concentration of electrolytes can negatively impact rheological properties of aqueous-based drilling fluids based on bentonite, marine life, and cutting carrying capacity of the aqueous-based drilling fluid.

In order to overcome the limitations of the electrolytes, polymers (e.g., guar gum, xanthan gum, hydroxyethyl cellulose, carboxymethyl cellulose, and the like) are often used as shale inhibitors in aqueous-based drilling fluids. Polymer-based shale inhibition depends on at least the concentration, structure, and charge of the polymers. Polymer-based shale inhibitors consist mainly of three categories, anionic polymers, cationic polymers, and non-ionic polymers. The use of polymers for shale inhibition include different types of polymeric products to control dispersion of shale cuttings by encapsulating clay and preventing its contact with water. Additionally, high molecular weight and salt tolerant polymers can be used to modify the rheological properties of an aqueous-based drilling fluid, such as viscosity, yield stress, gel strength thereof, with the additional benefit of shale inhibition. For instance, synthetic polymers, such polyacrylamide and partially hydrolyzed polyacrylamide, are often used as shale inhibitors for aqueous-based drilling fluids. These polymers are long chain macromolecules that adsorb onto the surface of clays and help prevent hydration and dispersion of clays in a wellbore during a drilling operation. However, such polymers often exhibit stability issues under downhole conditions. For example, polymers are susceptible to chemical, thermal, and mechanical degradation, thereby influencing their effectiveness as shale inhibitors.

The aqueous-based drilling fluid compositions comprising CTAB described herein may serve several functions in the drilling process. According to embodiments, the aqueous-based drilling fluid compositions can provide lubrication and cooling to the drill bit, aid with cleaning the wellbore by transporting rock cuttings from the drill bit to the surface, provide hydrostatic pressure in the wellbore to provide support to the sidewalls of the wellbore and prevent the sidewalls from collapsing and caving-in on the drill string, and provide hydrostatic pressure in the wellbore to prevent fluids in the downhole formations from flowing into the wellbore during drilling operations.

Embodiments in accordance with the present disclosure relate to the use of CTAB as a chemical shale inhibitor and wellbore stabilizer during drilling operations. Aqueous-based drilling fluids are provided which include an aqueous base fluid and CTAB. The aqueous-based drilling fluids may further comprise additional components, such as one or more additives to influence the characteristics of the drilling fluid, such as density and rheology. Aqueous-based drilling fluid comprising CTAB, compared to identical drilling fluids lacking CTAB, exhibit higher clay dispersion recovery. The dispersion capability of aqueous-based drilling fluids comprising CTAB is, without being bound by theory, believed to be due to plugging of clay pores and, thus, inhibiting water invasion. Intercalation and absorption of CTAB to the surface of clay hinders water molecules from invading the clay, which aids in mitigation of clay swelling by hindering or preventing hydration thereof.

The aqueous-based drilling fluids comprising CTAB of the present disclosure may be used during the drilling of clay-rich shale formations, such as Silurian shale formations (e.g., lower Silurian shale formations). Referring to FIG. 1, illustrated is an exemplary drilling system 100 that may employ the principles of the present disclosure. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure. As illustrated, the drilling system 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the wellbore 116. It is to be appreciated that all or a portion of wellbore 116 may be vertical (as shown), horizontal, or deviated, without departing from the scope of the present disclosure.

At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). One or more chemicals, fluids, or additives may be added to the drilling fluid 122 via a mixing hopper 134 communicably coupled to or otherwise in fluid communication with the retention pit 132.

The drilling system 100 may further include a bottom hole assembly (BHA) 136 arranged in the drill string 108 at or near the drill bit 114. The BHA 136 may include any of a number of sensor modules 138 (one shown) which may include formation evaluation sensors and directional sensors, such as measuring-while-drilling and/or logging-while-drilling tools. These sensors are well known in the art and are not described further. The BHA 136 may also contain a mud pulser system 140 which induces pressure fluctuations in the mud flow. Data from the downhole sensor modules 138 are encoded and transmitted to the surface via the pulser system 140 whose pressure fluctuations, or “pulses,” propagate to the surface through the column of mud flow in the drill string 108. At the surface the pulses are detected by one or more surface sensors (not shown), such as a pressure transducer, a flow transducer, or a combination of a pressure transducer and a flow transducer.

As described above, the present disclosure includes compositions, methods, and systems related to an aqueous-based drilling fluid comprising an aqueous base fluid and CTAB, which may include optional additional additives.

The aqueous base fluid of the aqueous-based drilling fluids of the present disclosure may include, but is not limited to, fresh water, deionized water, saltwater (e.g., water containing one or more salts dissolved therein), brine (e.g., saturated salt water), seawater, wastewater, produced water, and any combination thereof.

The aqueous-based drilling fluids further comprise at least CTAB acting as a shale inhibitor to stabilize a wellbore during drilling operations into shale formations. CTAB is a quaternary ammonium cationic surfactant that is capable of solubilizing and forming micelles in aqueous fluids. At 30° C., CTAB forms micelles having an aggregation number of about 75 to about 120, encompassing any value and subset therebetween, with an average aggregation number of about 95. The CTAB may reduce dispersion of shale cuttings by encapsulating clay minerals, modifying clay surfaces, or other mechanism for reducing or inhibiting clay swelling within a shale formation during drilling operations. The CTAB may further serve as a fluid loss material and/or a biocide, for example.

The CTAB included in the aqueous-based drilling fluids of the present disclosure is stable under downhole conditions. Specifically, the CTAB may be thermally stable in the range of about 50° C. to about 120° C., encompassing any value and subset therebetween, such as about 50° C. to about 100° C., or about 75° C. to about 120° C., or about 100° C. to about 120° C.

In one or more embodiments of the present disclosure, the CTAB may be included in the aqueous-based drilling fluids of the present disclosure in the range of about 0.01 percent by weight (wt %) of the total weight of the aqueous-based drilling fluid to about 5.0 wt % of the total weight of the aqueous-based drilling fluid, encompassing any value and subset therebetween, such as about 0.01 wt % to about 4.5 wt %, or about 0.01 wt % to about 3.0 wt %, or about 0.01 wt % to about 1.0 wt %, or about 0.01 wt % to about 0.5 wt %, or about 0.05 wt % to about 5.0 wt %, or about 0.05 wt % to about 3.0 wt %, or about 0.05 wt % to about 1.0 wt %, or about 0.05 wt % to about 0.5 wt %, or about 0.1 wt % to about 3.0 wt %, or about 0.1 wt % to about 1.0 wt %, or about 0.1 wt % to about 0.3 wt %, or about 0.3 wt % to about 0.7 wt %, or about 0.3 wt % to about 0.5 wt %, or about 0.5 wt % to about 0.7 wt % of the total weight of the aqueous-based drilling fluid.

An example aqueous-based drilling fluid composition may include from about 0.1 pounds per barrel (lbm/bbl) to about 25 lbm/bbl CTAB based on the total volume of the aqueous-based drilling fluid, encompassing any value and subset therebetween, such as about 0.1 lbm/bbl to about 20 lbm/bbl, or about 0.1 lbm/bbl to about 15 lbm/bbl, or about 0.1 lbm/bbl to about 10 lbm/bbl, or about 0.1 lbm/bbl to about 5 lbm/bbl, or about 1 lbm/bbl to about 25 lbm/bbl, or about 1 lbm/bbl to about 20 lbm/bbl, or about 1 lbm/bbl to about 15 lbm/bbl, or about 1 lbm/bbl to about 10 lbm/bbl, or about 1 lbm/bbl to about 5 lbm/bbl, or about 5 lbm/bbl to about 25 lbm/bbl, or about 5 lbm/bbl to about 20 lbm/bbl, or about 5 lbm/bbl to about 15 lbm/bbl, or about 5 lbm/bbl to about 10 lbm/bbl, or about 10 lbm/bbl to about 25 lbm/bbl, or about 10 lbm/bbl to about 20 lbm/bbl, or about 10 lbm/bbl to about 15 lbm/bbl, or about 15 lbm/bbl to about 25 lbm/bbl of the total volume of the aqueous-based drilling fluid composition. In some embodiments, the aqueous-based drilling fluid includes from about 1 lbm/bbl to about 20 lbm/bbl, encompassing any value and subset therebetween.

The rheological properties of the aqueous-based drilling fluid described herein may be determined by measuring the shear stress on the aqueous-based drilling fluid at different shear rates. The various shear rates are utilized since aqueous-based drilling fluids behave as a rigid body at lesser shear stresses but flow as a viscous fluid at greater shear stresses. The rheology of the aqueous-based drilling fluid may be characterized by the plastic viscosity (PV) and the yield point (YP), which are parameters from the Bingham plastic rheology model. The plastic viscosity is related to the resistance of an aqueous-based drilling fluid to flow due to mechanical interaction between solids, such as fines, in the aqueous-based drilling fluid. The plastic viscosity represents the viscosity of the aqueous-based drilling fluid extrapolated to infinite shear rate. The plastic viscosity is expressed in centipoise (cP). The plastic viscosity of an aqueous-based drilling fluid may be estimated by measuring the shear stress of the aqueous-based drilling fluid using a rheometer at spindle speeds of 300 rotations per minute (rpm) and 600 rpm and subtracting the 300 rpm dial reading from the 600 rpm dial reading according to Equation (I): PV (cP)=(Dial Reading at 600 rpm)−(Dial Reading at 300 rpm).

In some embodiments, the aqueous-based drilling fluid may have a PV in the range of about 1 cP to about 25 cP, encompassing any value and subset therebetween, such as about 1 cP to about 20 cP, about 1 cP to about 15 cP, about 1 cP to about 10 cP, about 1 cP to about 5 cP, about 5 cP to about 25 cP, about 5 cP to about 20 cP, about 5 cP to about 15 cP, about 5 cP to about 10 cP, about 10 cP to about 25 cP, about 10 cP to about 20 cP, about 10 cP to about 15 cP, about 15 cP to about 25 cP, about 15 cP to about 20 cP, or about 20 cP to about 25 cP.

Aqueous-based drilling fluids may behave as a rigid body when the shear stress is less than the yield point (YP), and aqueous-based drilling fluids may flow as a fluid when the shear stress is greater than the yield point. That is, the yield point represents the amount of stress required to move the drilling fluid from a static condition. The yield point of an aqueous-based drilling fluid is expressed as a force per area, such as pounds per one hundred square feet (lbf/100 ft²). Yield point provides an indication of the ability of an aqueous-based drilling fluid to carry solids, such as rock cuttings, through the annulus, which, in simplified terms, gives an indication of the ability of an aqueous-based drilling fluid to lift cuttings away from the bottom of a subterranean shale formation. The yield point of an aqueous-based drilling fluid is determined by extrapolating the Bingham plastic rheology model to a shear rate of zero. The yield point of an aqueous-based drilling fluid may be estimated from the plastic viscosity of the aqueous-based drilling fluid (as measured in accordance with Equation I, as previously described) according to Equation (II): YP=(Dial Reading at 300 rpm)−PV.

In some embodiments, the aqueous-based drilling fluid may have a yield point of from about 1 lb_{f}/100 ft² to about 25 lb_{f}/100 ft², encompassing any value and subset therebetween, such as about 1 lb_{f}/100 ft² to about 20 lb_{f}/100 ft², or about 1 lb_{f}/100 ft² to about 15 lb_{f}/100 ft², or about 1 lb_{f}/100 ft² to about 10 lb_{f}/100 ft², or about 1 lb_{f}/100 ft² to about 5 lb_{f}/100 ft², or about 5 lb_{f}/100 ft² to about 25 lb_{f}/100 ft², or about 5 lb_{f}/100 ft² to about 20 lb_{f}/100 ft², or about 5 lb_{f}/100 ft² to about 15 lb_{f}/100 ft², or about 5 lb_{f}/100 ft² to about 10 lb_{f}/100 ft², or about 10 lb_{f}/100 ft² to about 25 lb_{f}/100 ft², or about 10 lb_{f}/100 ft² to about 20 lb_{f}/100 ft², or about 10 lb_{f}/100 ft² to about 15 lb_{f}/100 ft², or about 15 lb_{f}/100 ft² to about 25 lb_{f}/100 ft², or about 15 lb_{f}/100 ft² to about 20 lb_{f}/100 ft², or about 20 lb_{f}/100 ft² to about 25 lb_{f}/100 ft².

The gel strength of an aqueous-based drilling fluid refers to the shear stress of the aqueous-based drilling fluid measured at a shear rate less than 10 rpm following a defined period of time during which the aqueous-based drilling fluid is maintained in a static state. In some embodiments, the aqueous-based drilling fluids of the present disclosure may have a gel strength after 10 seconds of in the range of about 1 lb_{f}/100 ft² to about 15 lb_{f}/100 ft², encompassing any value and subset therebetween, such as about 1 lb_{f}/100 ft² to about 12 lb_{f}/100 ft² or about 1 lb_{f}/100 ft² to about 9 lb_{f}/100 ft² or about 1 lb_{f}/100 ft² to about 6 lb_{f}/100 ft², or about 1 lb_{f}/100 ft² to about 3 lb_{f}/100 ft², or about 3 lb_{f}/100 ft² to about 15 lb_{f}/100 ft², or about 3 lb_{f}/100 ft² to about 12 lb_{f}/100 ft², or about 3 lb_{f}/100 ft² to about 9 lb_{f}/100 ft², or about 3 lb_{f}/100 ft² to about 6 lb_{f}/100 ft², or about 6 lb_{f}/100 ft² to about 15 lb_{f}/100 ft², or about 6 lb_{f}/100 ft² to about 12 lb_{f}/100 ft², or about 6 lb_{f}/100 ft² to about 9 lb_{f}/100 ft², or about 9 lb_{f}/100 ft² to about 15 lb_{f}/100 ft², or about 9 lb_{f}/100 ft² to about 12 lb_{f}/100 ft², or about 12 lb_{f}/100 ft² to about 15 lb_{f}/100 ft². In other embodiments, the aqueous-based drilling fluid may have a gel strength after 10 minutes of in the range of about 1 lb_{f}/100 ft² to about 25 lb_{f}/100 ft², encompassing any value and subset therebetween, such as about 1 lb_{f}/100 ft² to about 20 lb_{f}/100 ft², or about 1 lb_{f}/100 ft² to about 15 lb_{f}/100 ft², or about 1 lb_{f}/100 ft² to about 10 lb_{f}/100 ft², or about 1 lb_{f}/100 ft² to about 5 lb_{f}/100 ft², or about 5 lb_{f}/100 ft² to about 25 lb_{f}/100 ft², or about 5 lb_{f}/100 ft² to about 20 lb_{f}/100 ft², or about 5 lb_{f}/100 ft² to about 15 lb_{f}/100 ft², or about 5 lb_{f}/100 ft² to about 10 lb_{f}/100 ft², or about 10 lb_{f}/100 ft² to about 25 lb_{f}/100 ft², or about 10 lb_{f}/100 ft² to about 20 lb_{f}/100 ft², or about 10 lb_{f}/100 ft² to about 15 lb_{f}/100 ft², or about 15 lb_{f}/100 ft² to about 25 lb_{f}/100 ft², or about 15 lb_{f}/100 ft² to about 20 lb_{f}/100 ft², or about 20 lb_{f}/100 ft² to about 25 lb_{f}/100 ft².

In some embodiments, the aqueous-based drilling fluids comprising CTAB described herein may further include an additive to influence certain qualities of the fluid. Examples of suitable additives include, but are not limited to, emulsifiers, acids, alkalinity agents, pH stabilizers, fluorides, fluid loss control additives, hardness controllers, gases, nitrogen, carbon dioxide, surface modifying agents, tackifying agents, foamers, corrosion inhibitors, scale inhibitors, catalysts, clay control agents, biocides, bactericides, friction reducers, antifoam agents, bridging agents, dispersants, flocculants, HS scavengers, CO₂ scavengers, oxygen scavengers, friction reducers, viscosifiers, breakers, relative permeability modifiers, resins, wetting agents, coating enhancement agents, filter cake removal agents, rheology modifiers, filtration control agents, defoamers, surfactants, non-CTAB shale stabilizers, oils, and the like, and any combination thereof. One or more of these additives may comprise degradable materials that are capable of undergoing irreversible degradation downhole.

In some embodiments, the aqueous-based drilling fluid may be formulated to have specific characteristics, such as increased viscosity and density using one or more of the aforementioned additives. For example, the aqueous-based drilling fluid may be formulated to have a density in a range suitable to provide the necessary hydrostatic pressure to support the sidewalls of the wellbore and prevent fluids in the formation from flowing into the wellbore. Additionally, the aqueous-based drilling fluid may be formulated to have viscosity in the aforementioned range suitable to allow the aqueous-based drilling fluid to be pumped down through the drill string while still capturing and conveying rock cuttings from the bottom of the shale subterranean formation. Particular additives for achieving these purposes and others may include, for example, viscosifiers, fluid loss control agents, weighting agents, bridging agents, and any combination thereof.

Viscosifiers may also be referred to as rheology modifiers. Viscosifiers may impart non-Newtonian fluid rheology to an aqueous-based drilling fluid comprising CTAB according to the present disclosure, create a flat viscosity profile of the aqueous-based drilling fluid in annular flow, or both, thereby facilitating the lifting and conveying of rock cuttings from the bottom of a shale subterranean formation to the surface during drilling operations. In various embodiments, the viscosifier may include, but is not limited to, polysaccharides, bentonite, polyacrylamides, polyanionic cellulose, or combinations of these. For example, the viscosifier may include xanthan gum (XCP). The aqueous-based drilling fluids of the present disclosure may include a viscosifier in an amount sufficient to impart non-Newtonian fluid rheology to the aqueous-based drilling fluid, create a flat viscosity profile of the aqueous-based drilling fluid in annular flow, or both. In various embodiments, the aqueous-based drilling fluid may include a viscosifier in an amount in the range of about 0.01 lbm/bbl to about 5 lbm/bbl based on the total volume of the aqueous-based drilling fluid, encompassing any value and subset therebetween, such as about 0.01 lbm/bbl to about 4 lbm/bbl, or about 0.01 lbm/bbl to about 3 lbm/bbl, or about 0.01 lbm/bbl to about 2 lbm/bbl, or about 0.01 lbm/bbl to about 1 lbm/bbl, or about 0.01 lbm/bbl to about 0.5 lbm/bbl, or about 0.5 lbm/bbl to about 5 lbm/bbl, or about 0.5 lbm/bbl to about 4 lbm/bbl, or about 0.5 lbm/bbl to about 3 lbm/bbl, or about 0.5 lbm/bbl to about 2 lbm/bbl, or about 0.5 lbm/bbl to about 1 lbm/bbl, or about 1 lbm/bbl to about 5 lbm/bbl, or about 1 lbm/bbl to about 4 lbm/bbl, or about 1 lbm/bbl to about 3 lbm/bbl, or about 1 lbm/bbl to about 2 lbm/bbl, or about 2 lbm/bbl to about 5 lbm/bbl, or about 2 lbm/bbl to about 4 lbm/bbl, or about 2 lbm/bbl to about 3 lbm/bbl, or about 3 lbm/bbl to about 5 lbm/bbl, or about 3 lbm/bbl to about 4 lbm/bbl, or about 4 lbm/bbl to about 5 lbm/bbl based on the total volume of the aqueous-based drilling fluid.

Fluid loss control agents may reduce or prevent leakage of the aqueous-based drilling fluid into a shale subterranean formation. This leakage may result in undesirable damage to the subterranean formation, or both. In some embodiments, the fluid loss control agent may include starch, carboxymethyl starch, carboxymethylcellulose, and any combination thereof. The aqueous-based drilling fluid may include a fluid loss control agent in an amount sufficient to reduce or prevent the leakage of the aqueous-based drilling fluid into a subterranean formation. In various embodiments, the aqueous-based drilling fluid may include a fluid loss control agent in an amount of from about 0.1 lbm/bbl to about 10 lbm/bbl based on the total volume of the aqueous-based drilling fluid, encompassing any value and subset therebetween, such as about 0.1 lbm/bbl to about 7.5 lbm/bbl, or about 0.1 lbm/bbl to about 5 lbm/bbl, or about 0.1 lbm/bbl to about 2.5 lbm/bbl, or about 0.1 lbm/bbl to about 1 lbm/bbl, or about 1 lbm/bbl to about 10 lbm/bbl, or about 1 lbm/bbl to about 7.5 lbm/bbl, or about 1 lbm/bbl to about 5 lbm/bbl, or about 1 lbm/bbl to about 2.5 lbm/bbl, or about 2.5 lbm/bbl to about 10 lbm/bbl, or about 2.5 lbm/bbl to about 7.5 lbm/bbl, or about 2.5 lbm/bbl to about 5 lbm/bbl, or about 5 lbm/bbl to about 10 lbm/bbl, or about 5 lbm/bbl to about 7.5 lbm/bbl, or about 7.5 lbm/bbl to about 10 lbm/bbl based on the total volume of the aqueous-based drilling fluid.

Weighting agents may include finely divided solid particles (less than about 50 μm) that may be dispersed in the aqueous-based drilling fluid. Weighting agents may increase the density of the aqueous-based drilling fluid to support the sidewalls of the wellbore. Weighting agents may also increase the hydrostatic pressure of the aqueous-based drilling fluid to reduce or prevent fluids present in the subterranean formation from flowing into the wellbore. In some embodiments, the weighting agent may include barite, hematite, calcium carbonate, siderite, ilmenite, and any combination thereof. In various embodiments, the aqueous-based drilling fluid may include a weighting agent in an amount sufficient for the aqueous-based drilling fluid to achieve a density of from about 50 pounds per cubic foot (pcf) to about 150 pcf as measured in accordance with the American Petroleum Institute (API) recommended practice 13B-1, encompassing any value and subset therebetween, such as about 50 pcf to about 125 pcf, or about 50 pcf to about 100 pcf, or about 50 pcf to about 75 pcf, or about 75 pcf to about 150 pcf, or about 75 pcf to about 125 pcf, or about 75 pcf to about 100 pcf, or about 100 pcf to about 150 pcf, or about 100 pcf to about 125 pcf, or about 125 pcf to 150 about pcf. In certain embodiments, the aqueous-based drilling fluid may include a weighting agent in an amount of from about 1 lbm/bbl to about 200 lbm/bbl based on the total volume of the aqueous-based drilling fluid, encompassing any value and subset therebetween, such as about 1 lbm/bbl to about 150 lbm/bbl, or about 1 lbm/bbl to about 100 lbm/bbl, or about 1 lbm/bbl to about 50 lbm/bbl, or about 50 lbm/bbl to about 200 lbm/bbl, or about 50 lbm/bbl to about 150 lbm/bbl, or about 50 lbm/bbl to about 100 lbm/bbl, or about 100 lbm/bbl to about 200 lbm/bbl, or about 100 lbm/bbl to about 150 lbm/bbl, or about 150 lbm/bbl to about 200 lbm/bbl based on the total volume of the aqueous-based drilling fluid.

Bridging agents may include solids (less than about 50 μm) that bridge across pore throats in a shale subterranean formation and reduce or prevent the leakage of the aqueous-based drilling fluid into the subterranean formation. In certain embodiments, the bridging agent may include calcium carbonate, suspended salts, oil-soluble-resins, and any combination thereof. The bridging agent may be selected based on their average size, which may be determined with regard to the properties of the subterranean formation. For example, the bridging agent may include calcium carbonate with an average particle size of less than about 50 μm, calcium carbonate with an average particle size of 25 μm, calcium carbonate with an average particle size of less than 25 μm, and any combination thereof. In some embodiments, the aqueous-based drilling fluid may include a bridging agent in an amount sufficient to reduce or prevent the leakage of the aqueous-based drilling fluid into a subterranean formation. In some embodiments, the aqueous-based drilling fluid may include a bridging agent in an amount in the range of about 0.1 lbm/bbl to about 20 lbm/bbl based on the total volume of the aqueous-based drilling fluid, encompassing any value and subset therebetween, such as about 0.1 lbm/bbl to about 15 lbm/bbl, or about 0.1 lbm/bbl to about 10 lbm/bbl, or about 0.1 lbm/bbl to about 5 lbm/bbl, or about 0.1 lbm/bbl to about 1 lbm/bbl, or about 1 lbm/bbl to about 20 lbm/bbl, or about 1 lbm/bbl to about 15 lbm/bbl, or about 1 lbm/bbl to about 10 lbm/bbl, or about 1 lbm/bbl to about 5 lbm/bbl, or about 5 lbm/bbl to about 20 lbm/bbl, or about 5 lbm/bbl to about 15 lbm/bbl, or about 5 lbm/bbl to about 10 lbm/bbl, or about 10 lbm/bbl to about 20 lbm/bbl, or about 10 lbm/bbl to about 15 lbm/bbl, or about 15 lbm/bbl to about 20 lbm/bbl based on the total volume of the aqueous-based drilling fluid.

The present disclosure is also directed to the use of the aqueous-based drilling fluids comprising CTAB as described herein in drilling operations, such as drilling a subterranean well. Accordingly, methods for drilling a subterranean well may include operating a drill in a subterranean formation in the presence of an aqueous-based drilling fluid comprising CTAB. The aqueous-based drilling fluid may be in accordance with any of the embodiments previously described. Introducing the aqueous-based drilling fluid may involve injecting the drilling fluid into the subterranean formation, such as through a drill string connected to a drill bit. In particular embodiments, the subterranean formation may be a shale formation. The aqueous-based drilling fluid may at least be partially circulated within the subterranean formation. Recirculating the aqueous-based drilling fluid may allow the aqueous-based drilling fluid to cool and lubricate the drill bit and to lift rock cuttings away from the drill bit, carrying the rock cuttings upwards to the surface to clean the wellbore. The aqueous-based drilling fluid may additionally provide hydrostatic pressure to support the sidewalls of the wellbore and prevent the sidewalls from collapsing onto the drill string.

Embodiments disclosed herein include:
Embodiment A. A method comprising: providing a drilling fluid comprising: an aqueous base fluid, and a shale inhibitor comprising cetyltrimethylammonium bromide (CTAB); and drilling at least a portion of a wellbore into a subterranean formation in the presence of the drilling fluid.
Embodiment B. A drilling fluid comprising: an aqueous base fluid, and a shale inhibitor comprising cetyltrimethylammonium bromide (CTAB).
Embodiment C. A system comprising: a drill string extendable into a wellbore from a drilling platform and conveying a drilling fluid to a drill bit arranged at a distal end of the drill string, the drilling fluid comprising: an aqueous base fluid, and a shale inhibitor comprising cetyltrimethylammonium bromide (CTAB).

Each of embodiments A, B, and C may have one or more of the following additional elements in any combination:
Element 1: wherein the CTAB is present in the drilling fluid in an amount in the range of about 0.01 wt % to about 5.0 wt %.
Element 2: wherein the CTAB is present in the drilling fluid in an amount in the range of about 1 lbm/bbl to about 25 lbm/bbl.
Element 3: wherein the aqueous base fluid is selected from the group consisting of fresh water, deionized water, saltwater, brine, seawater, wastewater, produced water, and any combination thereof.
Element 4: wherein the drilling fluid is substantially free of solid particles having a size larger than about 50 μm.
Element 5: wherein the drilling fluid has a plastic viscosity in the range of about 1 cP to about 25 cP.
Element 6: wherein the drilling fluid has a yield point in the range of about 1 lb_{f}/100 ft² to about 25 lb_{f}/100 ft².
Element 7: wherein the drilling fluid has a gel strength in the range of about 1 lb_{f}/100 ft² to about 15 lb_{f}/100 ft².
Element 8: wherein the drilling fluid further comprises an additive selected from the group consisting of a viscosifier, a fluid loss control agent, a weighting agent, a bridging agent, and any combination thereof.

By way of non-limiting example, exemplary combinations applicable to Embodiments A, B, and C include any one, more, or all of Elements 1-8, in any combination without limitation.

To facilitate a better understanding of the aspects of the present disclosure, the following examples of preferred or representative aspects are given. In no way should the following examples be read to limit, or to define, the scope of the disclosure.

### EXAMPLES

EXAMPLE 1: In this Example, the swelling inhibition of shale formation rock of aqueous-based drilling fluids comprising (experimental sample, E1-E3) or lacking (control sample, C1) CTAB were evaluated. The concentration of CTAB used was 0.75 g in 350 mL of fluid (it is noted that other concentrations may be used, such as 1.5 g and 2.5 g in fluid). Each of the two studied drilling fluids comprised XCP (xanthan gum) as a viscosifier. Each of E1-E3 and C1 were dispersion tested, as follows. First, lower Silurian shale samples were obtained, crushed, and sorted using a sieve shaker (W.S. TYLER®, Mentor, OH) between mesh no. 10 and mesh no. 5 to mimic shale rock cuttings. To measure the dispersion of the shale, 20 grams (g) of the shale cuttings was added to 350 milliliters (mL) of water and 1 g of XCP. Various concentrations of CTAB was added to the E1-E3 sample, as provided in Table 1 below. The samples were hot rolled at 25 rpm and 65.5° C. (149.9° F.) for 16 hours in a rolling oven (OFI Testing Equipment, Inc., Houston, TX) in order to mimic downhole conditions. The shale cuttings were thereafter sieved with mesh no. 35 and washed in fresh water to remove any small shale particles. Next, the shale cuttings were desiccated at 105° C. (221° F.) for 24 hours. Finally, the shale cuttings were weighed and the % recovery was calculated according to Equation (III): (W_{c}/20)(100), where W_{c} is the weight of the remaining shale cuttings after the dispersion test. The results are shown in Table 1 below.

TABLE 1

| | | Weight Before | Weight After |
|---|---|---|---|
| Sample | CTAB (g) | Testing (g) | Testing (g) |
| E1 | 0.75 | 20 | 18.30 |
| E2 | 1.5 | 20 | 18.50 |
| E3 | 2.5 | 20 | 18.55 |
| C1 | — | 20 | 17.21 |

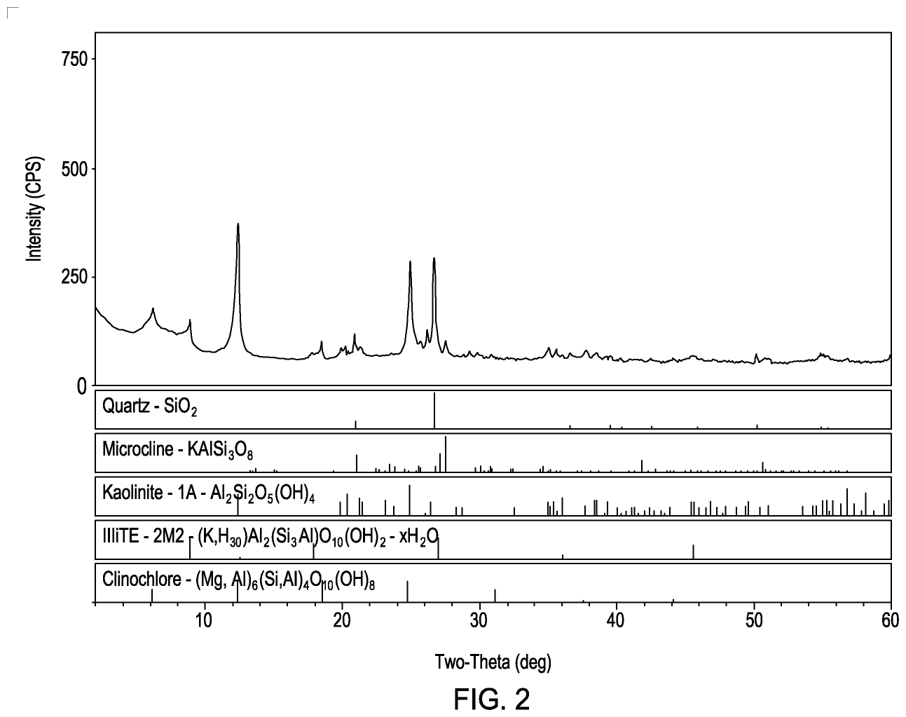

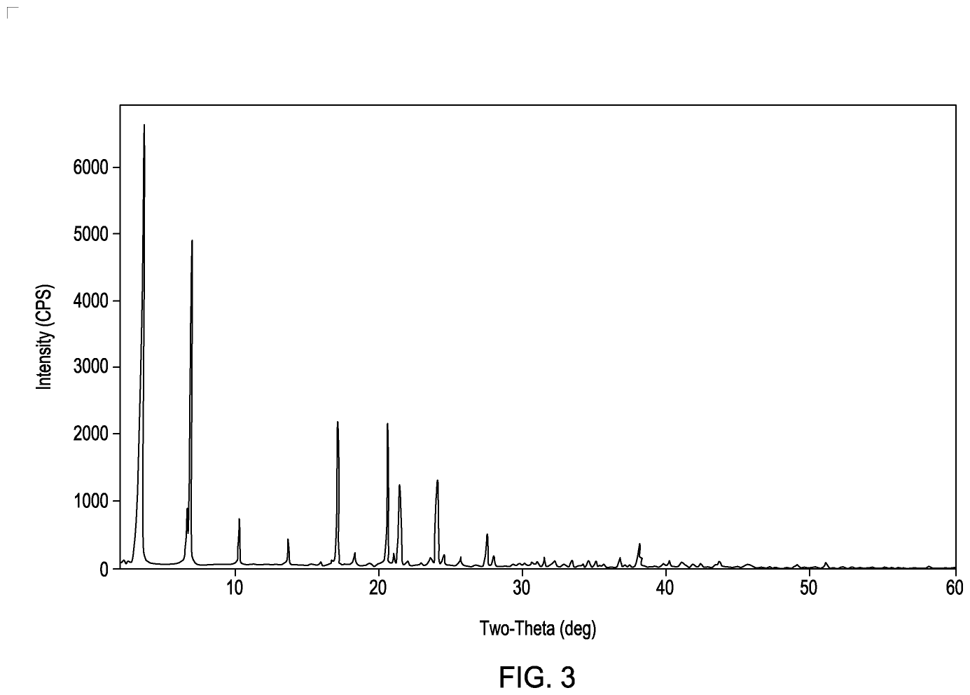

As is evident from the results shown in Table 1, the dispersion test demonstrates that the aqueous-based drilling fluid samples E1-E3 exhibited higher shale recovery compared to the C1 (no CTAB) control sample. Moreover, as the CTAB concentration increased, the shale recovery also increased.
EXAMPLE 2: In this Example, x-ray diffraction (XRD) of a lower Silurian period shale sample was evaluated compared to XRD of CTAB, both to evaluate their crystalline structures. The results are shown in FIG. 2 and FIG. 3, respectively. Table 2 below provides quantitative values for the detected compounds shown in FIG. 2.

TABLE 2

| Detected Compound | wt % |
|---|---|
| Quartz (SiO₂) | 36 |
| Illite ((K, H₃O)AL₂(SiAl)O₁₀(OH)₂•H₂O) | 26 |
| Muscovite ((K, Na)(Al, Mg, Fe)₂(Si_{3.1}Al_{0.9})O₁₀(OH₂)) | |
| Microcline (KAlSi₃O₈) | 11 |
| Kaolinite (Al2Si₂O₅(OH)₄) | 8 |
| Clinochlore ((Mg, Al)₆(Si, Al)₄O₁₀(OH)₈) | 19 |

Table 2 summarizes the testing results of this Example, where shale cuttings were exposed to inhibitive fluid, as well as non-inhibitive fluid, and provides the difference in shale recovery. As shale recovery increases, shale inhibition is increased. As shown in Table 2 and FIG. 2, the shale formation is formed of quartz, illite, clinochlore (also referred to as chlorite), and kaolinite. In the case of kaolinite, it is noted that its structure is arranged such that a tetrahedral sheet is followed by an octahedral sheet in a ratio of 1:1. FIG. 2 shows the shale composition of the sample that was tested with inhibitor (CTAB). As shown, and discussed above, the sample comprised kaolinite and illite, which are two types of reactive clays that enable inhibition via the CTAB.

FIG. 3 is the XRD of the CTAB inhibitor, confirming its presence in the sample composition.

Therefore, the present disclosure provides an alternative shale inhibitor for use in an aqueous-based drilling fluid for use in drilling operations of a wellbore in a subterranean formation, such as a shale subterranean formation.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing.” “includes.” “including,” “comprises.” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and are not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

1. A method comprising:
providing a drilling fluid comprising:
an aqueous base fluid, and
a shale inhibitor consisting of cetyltrimethylammonium bromide (CTAB); and
drilling at least a portion of a wellbore into a subterranean formation in the presence of the drilling fluid.

2. (canceled)

3. The method of claim 1, wherein the CTAB is present in the drilling fluid in an amount in the range of about 1 lbm/bbl to about 25 lbm/bbl.

4. The method of claim 1, wherein the aqueous base fluid is selected from the group consisting of fresh water, deionized water, saltwater, brine, seawater, wastewater, produced water, and any combination thereof.

5. The method of claim 1, wherein the drilling fluid is free of solid particles having a size larger than about 50 μm.

6. The method of claim 1, wherein the drilling fluid has a plastic viscosity in the range of about 1 cP to about 25 cP.

7. The method of claim 1, wherein the drilling fluid has a yield point in the range of about 1 lb_{f}/100 ft² to about 25 lb_{f}/100 ft².

8. The method of claim 1, wherein the drilling fluid has a gel strength in the range of about 1 lb_{f}/100 ft² to about 15 lb_{f}/100 ft².

9. The method of claim 1, wherein the drilling fluid further comprises an additive selected from the group consisting of a viscosifier, a fluid loss control agent, a weighting agent, a bridging agent, and any combination thereof.

10. A drilling fluid comprising:
an aqueous base fluid, and
a shale inhibitor consisting of cetyltrimethylammonium bromide (CTAB).

11. (canceled)

12. The drilling fluid of claim 10, wherein the CTAB is present in the drilling fluid in an amount in the range of about 1 lbm/bbl to about 25 lbm/bbl.

13. The drilling fluid of claim 10, wherein the aqueous base fluid is selected from the group consisting of fresh water, deionized water, saltwater, brine, seawater, wastewater, produced water, and any combination thereof.

14. The drilling fluid of claim 10, wherein the drilling fluid is free of solid particles having a size larger than about 50 μm.

15. The drilling fluid of claim 10, wherein the drilling fluid has a plastic viscosity in the range of about 1 cP to about 25 cP.

16. The drilling fluid of claim 10, wherein the drilling fluid has a yield point in the range of about 1 lb_{f}/100 ft² to about 25 lb_{f}/100 ft².

17. The drilling fluid of claim 10, wherein the drilling fluid has a gel strength in the range of about 1 lb_{f}/100 ft² to about 15 lb_{f}/100 ft².

18. The drilling fluid of claim 10, wherein the drilling fluid further comprises an additive selected from the group consisting of a viscosifier, a fluid loss control agent, a weighting agent, a bridging agent, and any combination thereof.

19. A system comprising:
a drill string extendable into a wellbore from a drilling platform and conveying a drilling fluid to a drill bit arranged at a distal end of the drill string, the drilling fluid comprising:
an aqueous base fluid, and
a shale inhibitor consisting of cetyltrimethylammonium bromide (CTAB).

20. The system of claim 19, wherein the CTAB is present in the drilling fluid in an amount in the range of about 0.01 wt % to about 5.0 wt %.

21. The method of claim 1, wherein the subterranean formation includes kaolinite.
